(19) United States
(12) Patent Application Publication
(10) Pub. No.: US 2025/0054339 A1
(43) Pub. Date: Feb. 13, 2025

(54) ACTION LOCALIZATION APPARATUS, CONTROL METHOD, AND NON-TRANSITORY COMPUTER-READABLE STORAGE MEDIUM

(71) Applicant: NEC Corporation, Minato-ku, Tokyo (JP)

(72) Inventors: Karen Stephen, Tokyo (JP); Jianquan Liu, Tokyo (JP)

(73) Assignee: NEC Corporation, Minato-ku, Tokyo (JP)

(21) Appl. No.: 18/723,644

(22) PCT Filed: Jan. 6, 2022
(86) PCT No.: PCT/JP2022/000280

§ 371 Date: Jun. 24, 2024

(51) Int. Cl. G06V 40/20; G06V 10/764; G06V 10/771; G06V 10/82

(52) U.S. Cl. CPC G06V 40/20; G06V 10/764; G06V 10/771; G06V 10/82; G06V 2201/07

(57) ABSTRACT

An action localization apparatus acquires a target clip and detects persons from the target clip. The action localization apparatus generates a person clip from the target clip for each of the persons detected from the target clip, and extracts a feature map from each of the person clip. The action localization apparatus computes, for each of predefined action classes, an action score that indicates confidence of an action of that action class being included in the target clip based on the feature maps extracted from the person clips, and localizes each action whose action class has the action score larger than or equal to a threshold by performing class activation mapping on each of the person clips.

### TECHNICAL FIELD

The present disclosure generally relates to localization of actions captured in a video.

### BACKGROUND ART

Action localization is a process to localize actions captured in images: i.e., determine what actions are taken in which locations of images. PTL1 discloses a system that detects actions in a video using a neural network for loss prevention in the retail industry.

### CITATION LIST

### Patent Literature

PTL1: US Patent Publication US No. 2021/0248377

### Non Patent Literature

NPL1: Junnan Li, Jianquan Liu, Yongkang Wang, Shoji Nishimura, and Mohan Kankanhalli, “Weakly-Supervised Multi-Person Action Recognition in 360° Videos”, [online], Feb. 9, 2020, [retrieved on 2021 Nov. 10], retrieved from <arXiv, https://arxiv.org/pdf/2002.03266.pdf>

### SUMMARY OF INVENTION

### Technical Problem

An objective of the present disclosure is to provide a novel technique to localize actions captured in a video.

### Solution to Problem

The present disclosure provides an action localization apparatus that comprises at least one memory that is configured to store instructions and at least one processor. The processor is configured to execute the instructions to: acquire a target clip that is a sequence of target images, the target image being a fisheye image in which one or more persons are captured in substantially top-view; detect one or more persons from the target clip; generate a person clip from the target clip for each of the persons detected from the target clip, the person clip being a sequence of person images each of which is a partial region of the target image and includes the detected person corresponding to that person clip; extract a feature map from each of the person clip; compute, for each of predefined action classes, an action score that indicates confidence of an action of that action class being included in the target clip based on the feature maps extracted from the person clips, the action class being a type of action; and localize each action whose action class has the action score larger than or equal to a threshold by performing class activation mapping on each of the person clips.

The present disclosure further provides a control method that is performed by a computer. The control method comprises: acquiring a target clip that is a sequence of target images, the target image being a fisheye image in which one or more persons are captured in substantially top-view; detecting one or more persons from the target clip; generating a person clip from the target clip for each of the persons detected from the target clip, the person clip being a sequence of person images each of which is a partial region of the target image and includes the detected person corresponding to that person clip; extracting a feature map from each of the person clip; computing, for each of predefined action classes, an action score that indicates confidence of an action of that action class being included in the target clip based on the feature maps extracted from the person clips, the action class being a type of action; and localizing each action whose action class has the action score larger than or equal to a threshold by performing class activation mapping on each of the person clips.

The present disclosure further provides a non-transitory computer readable storage medium storing a program. The program that causes a computer to execute: acquiring a target clip that is a sequence of target images, the target image being a fisheye image in which one or more persons are captured in substantially top-view; detecting one or more persons from the target clip; generating a person clip from the target clip for each of the persons detected from the target clip, the person clip being a sequence of person images each of which is a partial region of the target image and includes the detected person corresponding to that person clip; extracting a feature map from each of the person clip; computing, for each of predefined action classes, an action score that indicates confidence of an action of that action class being included in the target clip based on the feature maps extracted from the person clips, the action class being a type of action; and localizing each action whose action class has the action score larger than or equal to a threshold by performing class activation mapping on each of the person clips.

### Advantageous Effects of Invention

According to the present disclosure, a novel technique to localize actions captured in a video is provided.

### BRIEF DESCRIPTION OF DRAWINGS

FIG. 1 illustrates an overview of an action localization apparatus of the first example embodiment.

FIG. 2 illustrates examples of the person clips.

FIG. 3 is a block diagram illustrating an example of a functional configuration of the action localization apparatus.

FIG. 4 is a block diagram illustrating an example of a hardware configuration of the action localization apparatus.

FIG. 5 is a flowchart illustrating an example flow of processes performed by the action localization apparatus.

FIG. 6 illustrates a case where the feature map represents spatial-temporal features of regions of the target person and surroundings thereof.

FIG. 7 illustrates an example way of computing action scores based on the feature maps.

FIG. 8 illustrates an example of the class activation maps.

FIG. 9 is a flowchart illustrating an example flow of the processes performed by the localization unit.

FIG. 10 illustrates the first example of the target clip being modified to show the result of the action localization.

FIG. 11 illustrates the second example of the target clip being modified to show the result of the action localization.

FIG. 12 illustrates an overview of the action localization apparatus of the second example embodiment.

FIG. 13 is a block diagram that illustrates an example of the functional configuration of the action localization apparatus of the second example embodiment.

FIG. 14 is a flowchart illustrating a flow of processes that are performed by the action localization apparatus of the second example embodiment.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary. In addition, predetermined information (e.g., a predetermined value or a predetermined threshold) is stored in advance in a storage device to which a computer using that information has access unless otherwise described.

### First Example Embodiment

### Overview

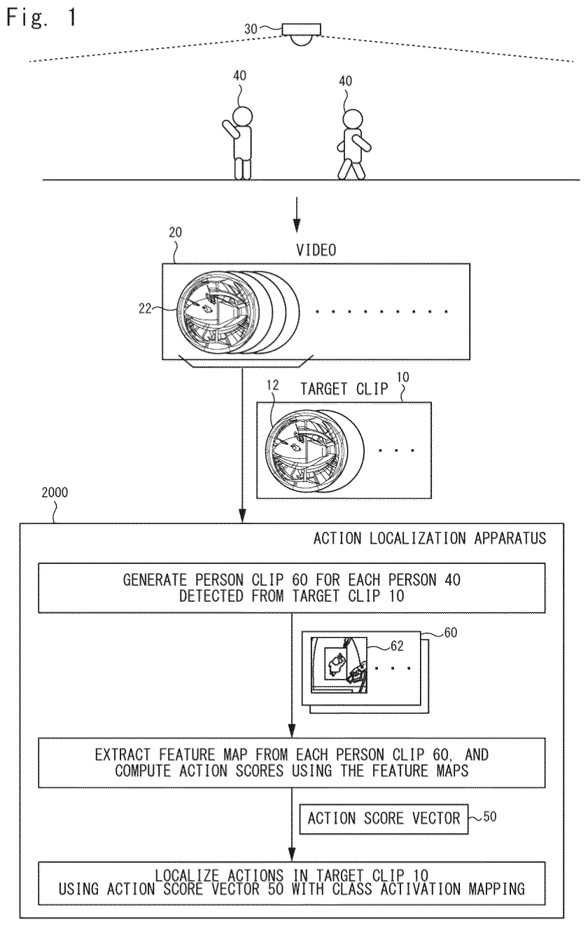

FIG. 1 illustrates an overview of an action localization apparatus 2000 of the first example embodiment. It is noted that the overview illustrated by FIG. 1 shows an example of operations of the action localization apparatus 2000 to make it easy to understand the action localization apparatus 2000, and does not limit or narrow the scope of possible operations of the action localization apparatus 2000.

The action localization apparatus 2000 handles a target clip 10, which is a part of a video 20 and is formed with a sequence of video frames 22. Each video frame 22 in the target clip 10 is called “target image 12”. The video 20 is a sequence of video frames 22 that are generated by a fisheye camera 30.

The fisheye camera 30 includes a fisheye lens and is installed as a top-view camera to capture a target place in top view. Thus, each video frame 22 (each target image 12 as well) is a fisheye top-view image in which the target place is captured in top view.

The target place may be arbitrary place. For example, in the case where the fisheye camera 30 is used as a surveillance camera, the target place is a place to be surveilled, such as a facility or its surroundings. The facility to be surveilled may be a train station, a stadium, etc.

It is note that it is preferable that the field of view of the fisheye camera 30 may be substantially close to 360 degrees in horizontal directions. However, it is not necessary that the field of view of the fisheye camera 30 is exactly 360 degrees in horizontal directions. In addition, the fisheye camera 30 may be installed so that the optical axis of its fisheye lens is substantially parallel to the vertical direction. However, it is not necessary that the optical axis of the fisheye lens of the fisheye camera is exactly parallel to the vertical axis.

The action localization apparatus 2000 detects one or more persons 40 from the target clip 10, detects one or more actions taken by the detected persons 40, and localizes the detected actions (i.e., determines which type of actions are happened in which regions of the target clip 10). There may be various action classes, such as “walk”, “drink”, “put on jacket”, “play with phone”, etc. Specifically, the action localization apparatus 2000 may operate as follows.

The action localization apparatus 2000 acquires the target clip 10 and detects one or more persons 40 from the target clip 10. Then, the action localization apparatus 2000 generates a person clip 60 for each of the persons 40 detected from the target clip 10. Hereinafter, a person corresponding to the person clip 60 is called “target person”. The person clip 60 of a target person is a sequence of person images 62 each of which includes the target person and is cropped from the corresponding target image 12. Crop positions (positions in the target images 12 from which the person images 62 are cropped) and dimensions of the person images 62 in a single person clip 60 are the same as each other.

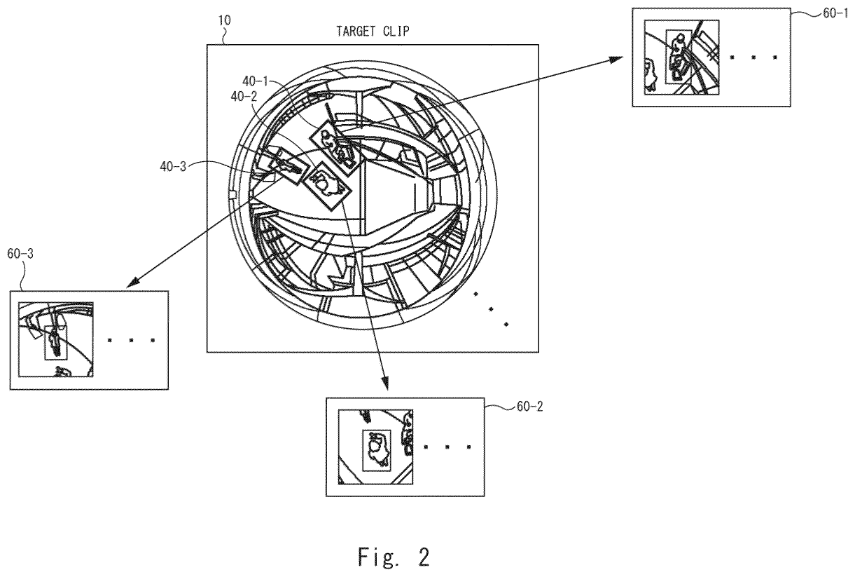

FIG. 2 illustrates examples of the person clips 60. In this example, the target clip 10 includes three persons 40-1 to 40-3. Thus, the person clips 60-1 to 60-3 are generated for the persons 40-1 to 40-3, respectively.

The action localization apparatus 2000 extracts a feature map from each of the person clips 60. The feature map represents a spatial-temporal features of the person clip 60. Then, the action localization apparatus 2000 computes an action score for each of predefined action classes based on the feature maps extracted from the person clips 60, to generate an action score vector 50. The action score of an action class represents confidence of one or more actions of the action class being included in the target clip 10 (in other words, confidence of one or more persons 40 in the target clip 10 being taking an action of the action class). The action score vector 50 is a vector that has the action score of each of the predefined action classes as its element.

Suppose that there are three predefined action classes: A1, A2, and A3. In this case, the action score vector is a three dimensional vector v=(c1, c2, c3) wherein c1 represents the action score of the action class A1 (i.e., the confidence of one or more actions of the action class A1 being included in the target clip 10), c2 represents the action score of the action class A2 (i.e., the confidence of one or more actions of the action class A2 being included in the target clip 10), and c3 represents the action score of the action class A3 (i.e., the confidence of one or more actions of the action class A3 being included in the target clip 10).

The action score vector 50 does not show which type of actions are taken in which regions of the target clip 10. Based on the feature maps obtained from the target clip 10 and the action score vector 50, the action localization apparatus 2000 localizes actions in the target clip 10 (i.e., determines which type of actions are happened in which regions of the target clip 10). This type of localization is called “action localization”.

The action localization apparatus 2000 performs the action localization for the target clip 10 with class activation mapping. Specifically, for each of the person clips 60 and for each of the action classes detected from the target clip 10, the action localization apparatus 2000 performs class activation mapping to determine which region in the person images 62 of that person clip 60 includes which type of action. As a result, each of the actions of the detected persons 40 are localized.

### Example of Advantageous Effect

According to the action localization apparatus 2000, a novel technique to localize actions captured in a video is provided as mentioned above. Specifically, the action localization apparatus 2000 generates the person clip 60 for each of the person 40 detected from the target clip 10, extracts the feature map for each person clip 60, and computes the action score vector that indicates the action score for each of the predefined action classes. Then, the action localization apparatus 2000 localize each action in the target clip 10 by determining, for each person clip 60, the action class of the action included in that person clip 60 using class activation mapping.

Hereinafter, more detailed explanation of the action localization apparatus 2000 will be described.

### Example of Functional Configuration

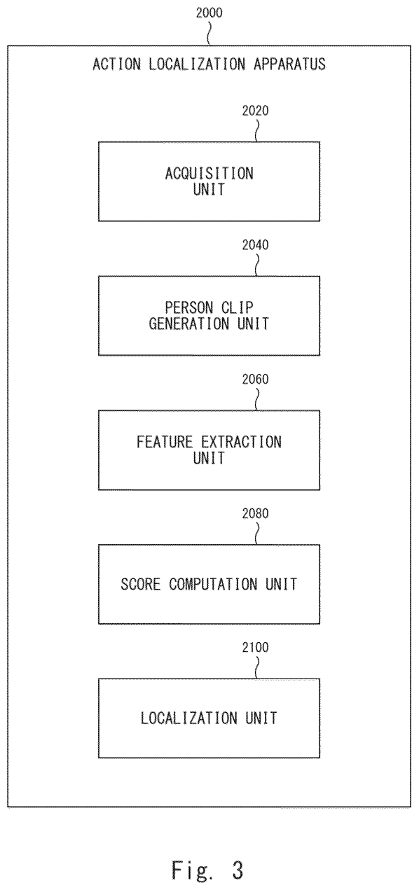

FIG. 3 is a block diagram illustrating an example of the functional configuration of the action localization apparatus 2000. The action localization apparatus 2000 includes an acquisition unit 2020, a person clip generation unit 2040, a feature extraction unit 2060, and a score computation unit 2080, and a localization unit 2100.

The acquisition unit 2020 acquires the target clip 10. The person clip generation unit 2040 generates the person clip 60 for each of the persons 40 detected from the target clip 10. The feature extraction unit 2060 extracts the feature map from each of the person clips 60. The score computation unit 2080 computes the action score for each of the predefined action classes to generate the action score vector 50 using the feature maps. The localization unit 2100 performs class activation mapping based on the action score vector 50 and the feature maps to localize the detected actions in the target clip 10.

### Example of Hardware Configuration

The action localization apparatus 2000 may be realized by one or more computers. Each of the one or more computers may be a special-purpose computer manufactured for implementing the action localization apparatus 2000, or may be a general-purpose computer like a personal computer (PC), a server machine, or a mobile device.

The action localization apparatus 2000 may be realized by installing an application in the computer. The application is implemented with a program that causes the computer to function as the action localization apparatus 2000. In other words, the program is an implementation of the functional units of the action localization apparatus 2000.

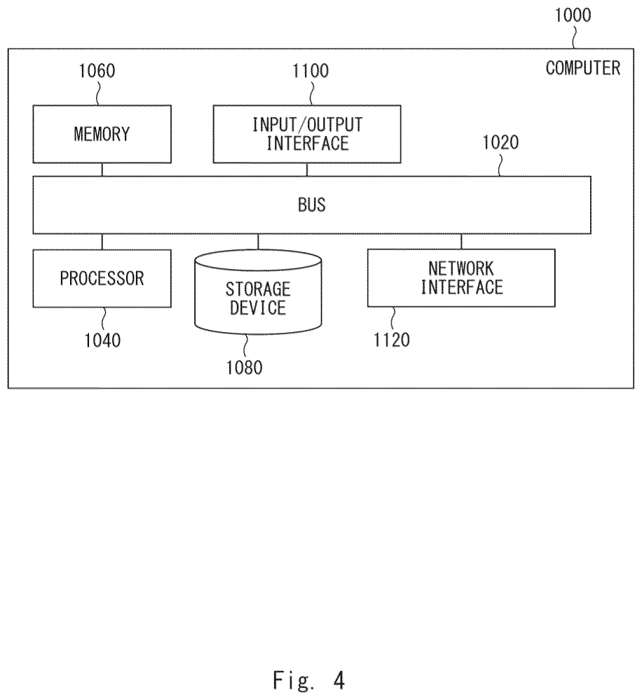

FIG. 4 is a block diagram illustrating an example of the hardware configuration of a computer 1000 realizing the action localization apparatus 2000. In FIG. 4, the computer 1000 includes a bus 1020, a processor 1040, a memory 1060, a storage device 1080, an input/output (I/O) interface 1100, and a network interface 1120.

The bus 1020 is a data transmission channel in order for the processor 1040, the memory 1060, the storage device 1080, and the I/O interface 1100, and the network interface 1120 to mutually transmit and receive data. The processor 1040 is a processer, such as a CPU (Central Processing Unit), GPU (Graphics Processing Unit), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The I/O interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network). In some implementations, the computer 500 is connected to the fisheye camera 30 through this network. The storage device 1080 may store the program mentioned above. The CPU 1040 executes the program to realize each functional unit of the action localization apparatus 2000.

The hardware configuration of the computer 1000 is not restricted to that shown in FIG. 4. For example, as mentioned-above, the action localization apparatus 2000 may be realized by plural computers. In this case, those computers may be connected with each other through the network.

One or more of the functional configurations of the action localization apparatus 2000 may be implemented in the fisheye camera 30. In this case, the fisheye camera 30 functions as a whole or a part of the computer 500. For example, in the case where all of the functional configurations of the action localization apparatus 2000 are implemented in the fisheye camera 30, the fisheye camera 30 may analyze the target clip 10 that is generated by itself, detect actions from the target clip 10, localize the detected actions in the target clip 10, and output information that shows the result of the action localization for the target clip 10. The fisheye camera 30 that works as mentioned above may be a network camera, an IP (internet protocol camera) or an intelligent camera.

### <Flow of Process>

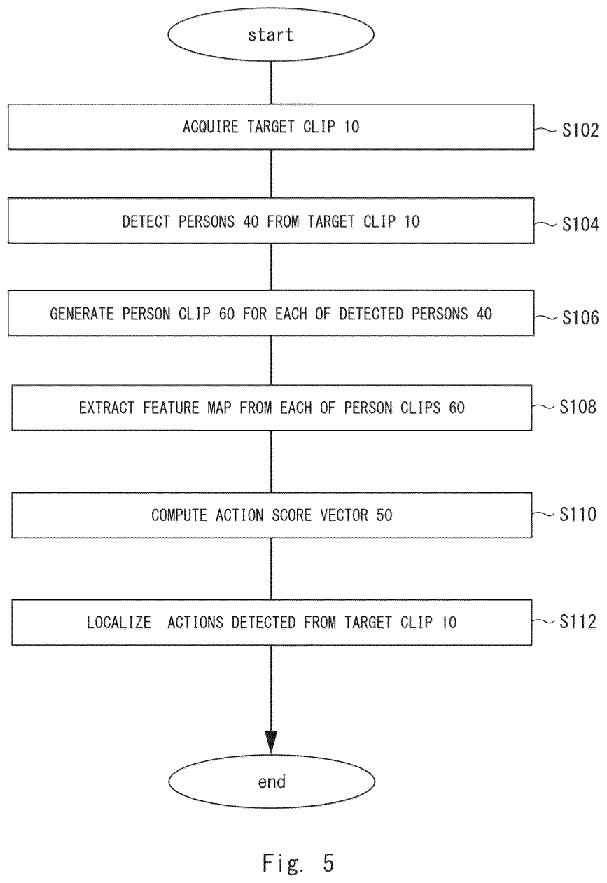

FIG. 5 is a flowchart illustrating an example flow of processes performed by the action localization apparatus 2000. The acquisition unit 2020 acquires the target clip 10 (S102). The person clip generation unit 2040 detects one or more persons 40 from the target clip 10 (S104). The person clip generation unit 2040 generates the person clip 60 for each of the detected persons 40 (S106). The feature extraction unit 2060 extracts the feature map from each of the person clips 60 (S108). The score computation unit 2080 generates the action score vector 50 based on the features maps (S110). The localization unit 2100 localizes the actions detected from the target clip 10 (S112).

### <Acquisition of Target Clip 10: S102>

The acquisition unit 2020 acquires the target clip 10 (S102). As described above, the target clip 10 is a part of the video 20 generated by the fisheye camera 30. The number of the target images 12 in the target clip 10 may defined in advance. Since multiple sequences of the predefined number of the video frames 22 may be extracted from different parts of the video 20, the action localization apparatus 2000 may handle each one of those sequences as the target clip 10. By doing so, the action localization apparatus 2000 may perform action localization on each one of different parts of the video 20.

There are various ways to obtain the target clip 10. For example, the acquisition unit 2020 may acquire the video 20 and divide it into multiple sequences of the predefined number of vide frames 22, thereby acquiring multiple target clips 10. The video 20 may be acquired by accessing a storage unit in which the video 20 is stored, or by receiving the video 20 that is sent from another computer, such as the fisheye camera 30.

In another example, the acquisition unit 2020 may periodically acquire one or more video frames 22. Then, the acquisition unit 2020 generates the target clip 10 with the predefined number of the acquired video frames 22. The acquisition unit 2020 can generate multiple target clips 10 by repeatedly performing the above processes. The video frames 22 may be acquired in a way similar to a way of acquiring the video 20 that is mentioned above.

### <Detection of Persons 40: S104>

The person clip generation unit 2040 detects one or more persons 40 from the target clip 10 (S104). It is noted that there are various well-known ways to detect a person from a sequence of fisheye images, and the person clip generation unit 2040 may be configured to use one of those ways to detect persons 40 from the target clip 10. For example, a machine learning-based model (called “person detection model”, hereinafter) is used to detect persons 40 from the target clip 10. The person detection model is configured to take a fisheye clip as an input and is trained in advance to output a region (e.g., bounding box) including a person for each person and for each fisheye video frame in the input fisheye clip in response to the fisheye clip being input thereto.

The person clip generation unit 2040 may detect persons 40 from a whole region of the target clip 10 or from a partial region of the target clip 10. In the latter case, for example, persons 40 are detected from a circular region in each of the target images 12 of the target clip 10. One of examples of this latter case will be described as the second example embodiment of the action localization apparatus 2000 later.

### <Generation of Person Clip 60: S106>

The person clip generation unit 2040 generates the person clip 60 for each of the person 40 detected from the target clip 10 (S106). The person clip 60 of a target person is a sequence of images called “person images 62” each of which is a partial region of the corresponding target image 12 and includes the target person therein. Hereinafter, a region that is cropped from the target image 12 to generate the person image 62 is called “crop region”. It is noted that dimensions (width and height) of the crop region may be predefined.

For each of the target persons (the persons 40 detected from the target clip 10), the person clip generation unit 2040 may operate as follows. The person clip generation unit 2040 rotates the target images 12 by the same angle as each other so that the target person is seen to stand substantially upright in each of the target images 12. For example, in the case where the person clip generation unit 2040 detects a bounding box for each person 40, the rotation angle of the target images 12 for the target person may be determined based on the orientation of the bounding box of the target person in a representative one (e.g., the first one) of the target images 12.

Next, the person clip generation unit 2040 determines the crop position (i.e., a position of the crop region) with which the crop region includes the target person in each of the rotated target images 12. Then, the person clip generation unit 2040 generates person images 12 by cropping images from the determined crop regions of the rotated target images 12, thereby generating the person clip 60 of the target person.

### <Feature Extraction: S108>

The feature extraction unit 2060 extracts the feature map from each of the person clips 60 (S108). The feature map represents spatial-temporal features of the person clip 60. The feature map may be extracted using a neural network, such as a 3D CNN (convolutional neural network), that is configured to take a clip and is trained in advance to output spatial-temporal features of the input clip as a feature map in response to the clip being input thereto.

The feature map may represent spatial-temporal features of a whole region of the person clip 60, or may represent those of partial region of the person clip 60. In the latter case, the feature map may represent spatial-temporal features of regions of the target person and surroundings thereof.

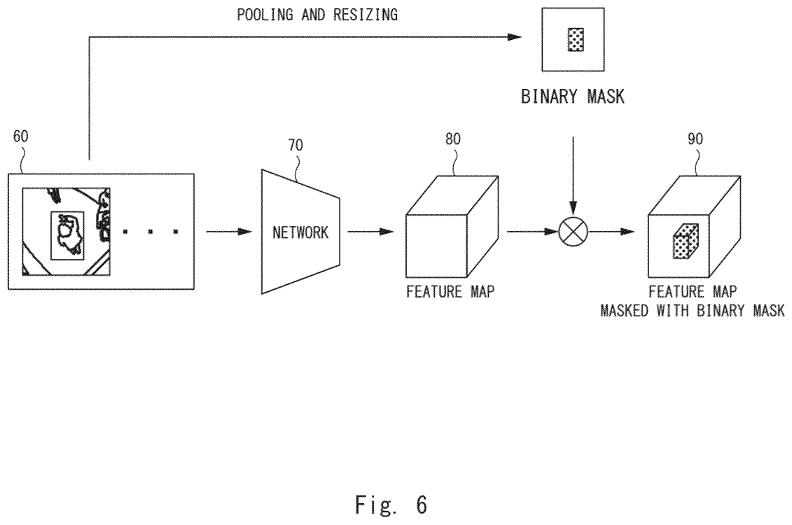

FIG. 6 illustrates a case where the feature map represents spatial-temporal features of regions of the target person and surroundings thereof. In FIG. 6, there is a network 70 that takes the person clip 60 as an input and outputs the feature map 80. The network 70 may be arbitrary type of a 3D CNN, such as 3D ResNet. In addition, the feature extraction unit 2060 performs pooling, such as max pooling, on bounding boxes of the target person across all of the person images 62, thereby obtaining a binary mask. The feature extraction unit 2060 resizes the binary mask to the same width and height as the feature map 80, and multiplies the feature map 80 with the resized mask to obtain the feature map 90. Hereinafter, the feature map that is output from the feature extraction unit 2060 is described as being “feature map 90” regardless of whether or not it is masked with the binary mask.

### <Computation of Action Scores: S110>

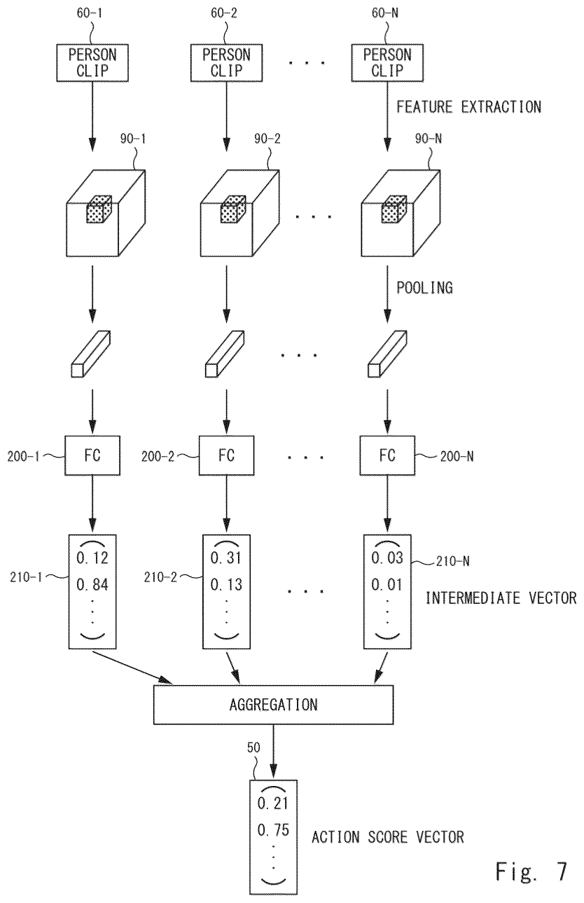

The score computation unit 2080 computes the action scores for the predefined action classes, thereby computing the action score vector 50 (S110). The feature maps 90 obtained from the person clips 60 are used to compute the action scores. In some implementations, the score computation unit 2080 may operate as illustrated by FIG. 7. FIG. 7 illustrates an example way of computing action scores based on the feature maps 90. In this example, person clips 60-1 and 60-N are obtained from the target clip 10, and the feature maps 90-1 to 90-N are obtained from the person clips 60-1 to 60-N, respectively.

First, the score computation unit 2080 performs pooling, e.g., average pooling, on each of the feature maps 90. Then, each of the results of the pooling is input into a fully connected layer 200. The fully connected layer 200 is configured to take a result of pooling on a feature map 90 and is trained in advance to output a vector called “intermediate vector 210” that represents, for each of the predefined action classes, confidence of an action of that action class being included in the person clips 60 corresponding to the feature map 90.

By using the fully connected layer 200, the intermediate vectors 210 are obtained for all of the feature maps 90. Then, the score computation unit 2080 aggregates the intermediate vectors 210 into the action score vector 50. The intermediate vectors 210 may be aggregated using a log sum exponential function, such as one disclosed by NPL1. It is noted that the action score vector 50 may be scaled so that the maximum range of each element becomes [0, 1].

### <Class Activation Mapping: S112>

The localization unit 2100 performs class activation mapping, such as CAM (class activation mapping), Grad-CAM, SmoothGrad, etc., to localize the actions detected from the target clip 10. The class activation mapping is a method to find one or more regions in an input image that are relevant to the result of predictions (the action score of an action class, in the case of the action localization apparatus 2000). For each of the action classes detected from the target clip 10 and for each of the person clips 60, the localization unit 2100 performs the class activation mapping to determine where actions of the detected action classes are taken in the target clip 10.

The action classes detected from the target clip 10 are action classes each of which has an action score larger than or equal to a predefined threshold Tc. Suppose that there are three predefined action classes A1, A2, and A3, and their action scores are 0.8, 0.3, and 0.7 respectively. In addition, the threshold Tc is 0.6. In this case, the detected action classes are the action classes A1 and A3 since their action scores are larger than the threshold Tc.

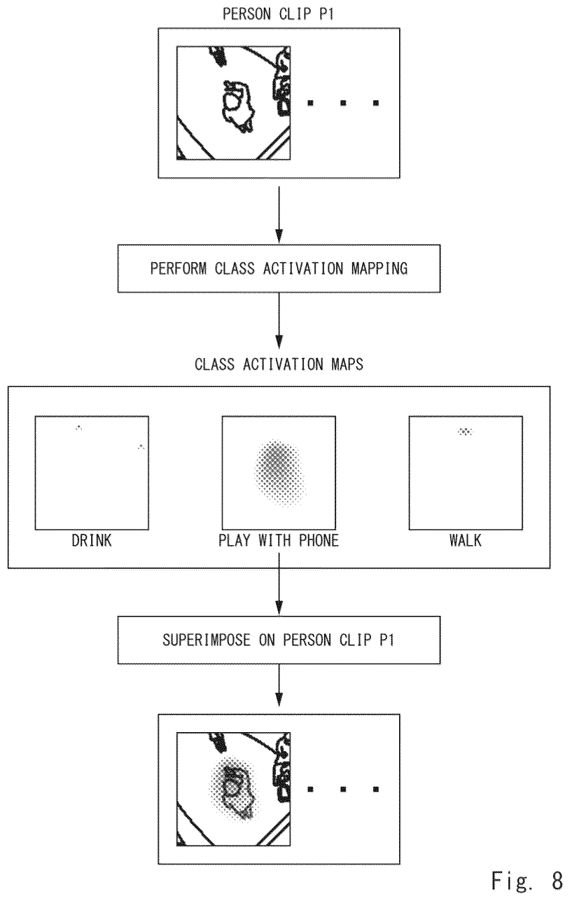

FIG. 8 illustrates an example of the class activation maps. This figure shows the class activation maps generated for the person clip P1. The person clip P1 includes an action of “play with phone”. Suppose that the detected actions are “drink”, “play with phone”, and “walk”. In this case, the localization unit 2100 generates the class activation map for each of these three detected actions. The darker a region in the class activation map is, the more the region is relevant to the prediction of the action score of the action class corresponding to the map. In addition, the darker a position in the class activation map is, the larger a value of the cell of the map that corresponds to that position is.

In FIG. 8, the class activation map for “play phone” has a dark and wide region, whereas the other two class activation maps do not have such a region. Thus, it can predict that the action include in the person clip P1 is of “play phone”. In addition, by superimposing the action class map for “play phone” on the person clip P1, it can predict a region of the person clip P1 in which the action of “play phone” is taken.

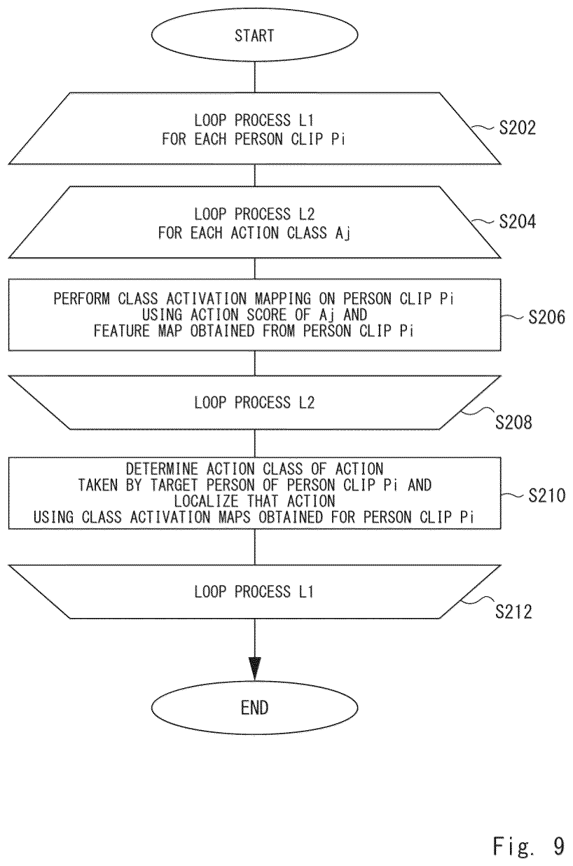

FIG. 9 is a flowchart illustrating an example flow of the processes performed by the localization unit 2100. Step S202 to S212 form a loop process L1 that is performed for each of the person clips 60. At Step S202, the localization unit 2100 determines whether or not the loop process L1 has been performed for all of the person clips 60. If the loop process L1 has been performed for all of the person clips 60, the processes illustrated by FIG. 9 are finished. On the other hand, if the loop process L1 has not been performed for all of the person clips 60, the localization unit 2100 selects one of the person clips 60 for which the loop process L1 is not performed yet. The person clip 60 selected here is described as being “person clip Pi”.

Step S204 to S208 form a loop process L2 that is performed for each of the detected action classes. At Step S204, the localization unit 2100 determines whether or not the loop process L2 has been performed for all of the detected action classes. If the loop process L2 has been performed for all of the detected action classes, S210 is performed next. On the other hand, if the loop process L2 has not been performed for all of the detected action classes, the localization unit 2100 selects one of the detected action classes for which the loop process L2 is not performed yet. The action class selected here is described as being “action class Aj”.

The localization unit 2100 performs class activation mapping on the person clip Pi using the action score of Aj indicated by the action sore vector 80 and the feature map 90 obtained from the person clip Pi (S206). As mentioned above, there are various types of class activation mappings, and any one of them can be employed.

For example, In the case of Grad-CAM is employed, the class activation map can be generated in a similar way to that disclosed by NPL1. Specifically, for each channel of the feature map 90 obtained from the person clip Pi, the localization unit 2100 computes the importance of the channel for the prediction of the action score of the action class Aj based on the gradient of the action score with respect to the channel. This can be formulated as follows.

$$\begin{matrix}Equation 1 & \\ w [ j ] [ k ] = \frac{1}{Z} {\sum }_{x , y} \frac{\partial S [ j ]}{\partial B [ k ] [ x ] [ y ]} & ( 1 )\end{matrix}$$

wherein w[j][k] represents the importance of the k-th channel of the feature map regarding the prediction of the action class Aj; 1/z*Σ represents a global average pooling; a pair of x and y represents a position in the channel; S[j] represents the action score of the action class Aj; and B [k][x][y] represents the cell of the k-th channel at the position (x,y).

Then, the class activation map is generated as a weighted combination of the channels of the feature map 90 of the person clip P1 using the importance of each channel computed above as the weight of each channel. This can be formulated as follows.

$$\begin{matrix}Equation 2 & \\ H [ j ] = ReLU ( {\sum }_{k} w [ j ] [ k ] * B [ k ] ) & ( 2 )\end{matrix}$$

wherein H[j] represents the class activation map generated for the action class Aj.

Step S208 is the end of the loop process L2, and thus Step S204 is performed next.

After the loop process L2 is finished for the person clip Pi, the localization unit 2100 has the class activation maps that are obtained from the person clip Pi for all of the detected action classes. At Step S210, the localization unit 2100 determines the action class of the action taken by the target person of the person clip Pi and localize that action based on the obtained class activation maps. To do so, the localization unit 2100 determines one of the class activation maps that corresponds to the action class of the action taken by the target person in the person clip Pi.

It can be said that the class activation map computed for the action class Aj includes a region showing high relevance to the action score of the action class Aj only if the target person of the person clip Pi takes the action of the action class Aj. Thus, the class activation map showing the highest relevance to the action score (the result of prediction of the action score) of the corresponding action class is one that corresponds to the action class of the action taken in the person clip P1.

Specifically, for example, the localization unit 2100 computes a total value of the cells for each of the class activation maps, and determine which class activation map has the largest total value. Then, the localization unit 2100 determines that the action class corresponding to the class activation map with the largest total value as the action class of the action taken in the person clip 60. This can be formulated as follows.

$$\begin{matrix}Equation 3 & \\ c [ i ] = {max}_{j} {\sum }_{x , y} H [ j ] [ x ] [ y ] & ( 3 )\end{matrix}$$

wherein c[i] represents the action class of the action taken in the person clip Pi, and H[j][x][y] represents the value of the cell at (x,y) of the class activation map H[j].
<Output from Action Localization Apparatus 2000>

The action localization apparatus 2000 may output information called “output information” that shows the result of action localization in space and time: i.e., which types of actions are taken in which regions of the target clip 10 in what period of time. There may be various types of information shown by the output information. In some implementations, the output information may include, for each of the actions of the detected action classes, a set of: the action class of that action; the location of that action being taken (e.g., the location of the bounding box of the person 40 who takes that action); and the period of time (e.g., frame numbers of the target clip 10) during which that action is taken. For example, the output information may include the target clip 10 that is modified to show, for each of the persons 40 detected from the target clip 10, the bounding box of that person 40 with an annotation indicating the action class of the action taken by that person 40.

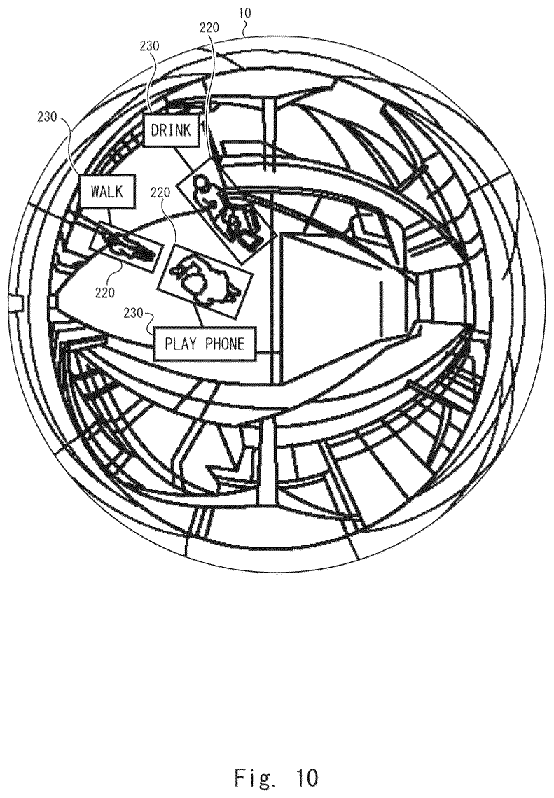

FIG. 10 illustrates the first example of the target clip 10 being modified to show the result of the action localization. In this example, the action classes of “drink”, “play phone”, and “walk” are detected, and those action classes are localized. To show this result, a pair of a bounding box 220 and an annotation 230 is superimposed on the target clip 10. The bounding box 220 shows the location of a detected person 40, and the corresponding annotation 230 shows the action class of the action taken by this person 40.

In other implementations, the output information may include the target clip 10 that is modified as the class activation maps of the detected action classes being superimposed thereon. Suppose that it is determined that the target person of the person clip Pi takes an action of the action class Aj. In this case, the target images 12 corresponding to the person images 62 of the person clip Pi are modified so that the class activation maps that are generated for a pair of the person clip Pi and the action class Aj are superimposed thereon. The location in the target image 12 on which the class activation map is to be superimposed is the location from which the corresponding person image 62 is cropped.

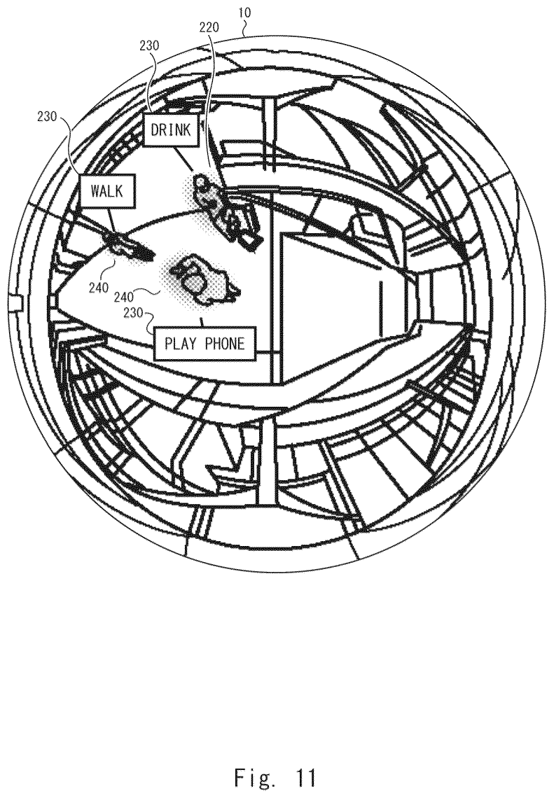

FIG. 11 illustrates the second example of the target clip 10 being modified to show the result of the action localization. This figure assumes the same situation as that of FIG. 10. However, instead of the bounding box 220, a map 240 is superimposed on the target clip 10 in FIG. 11. The map 240 superimposed on a person is the class activation map that is generated for the person clip 60 of that person and corresponds to the action class of the action taken by that person.

### <As to Optimization of Trainable Parameters>

The action localization apparatus 2000 has trainable parameters, such as weights in the network 70 and the fully connected layer 200. Those trainable parameters are optimized in advance (in other words, the action localization apparatus 2000 is trained in advance) by repeatedly updating them using multiples training data. The training data may include a pair of a test clip and a ground truth data of the action score vector 50. The test clip is arbitrary clip that is generated by a top-view fisheye camera (preferably, by the fisheye camera 30) and includes one or more persons. The ground truth data is an action score vector that indicates the maximum confidence (e.g., 1 when the action score vector 50 is scaled to [0,1]) for each of the action class that is included in the test clip.

The trainable parameters are updated based on a loss that indicates a difference between the ground truth data and the action score vector 50 that is computed by the action localization apparatus 2000 in response to the test clip being input thereinto. The loss may be computed using arbitrary types of loss function, such as cross entropy loss function. The loss function may further include a regularization term. For example, since the target person may take a single action in the person clip 60, it is preferable to add a penalty when the intermediate vector (an action score vector that is computed from a single feature map 80) indicates high confidence for multiple action classes. This type of regularization term is disclosed by NPL1.

### Second Example Embodiment

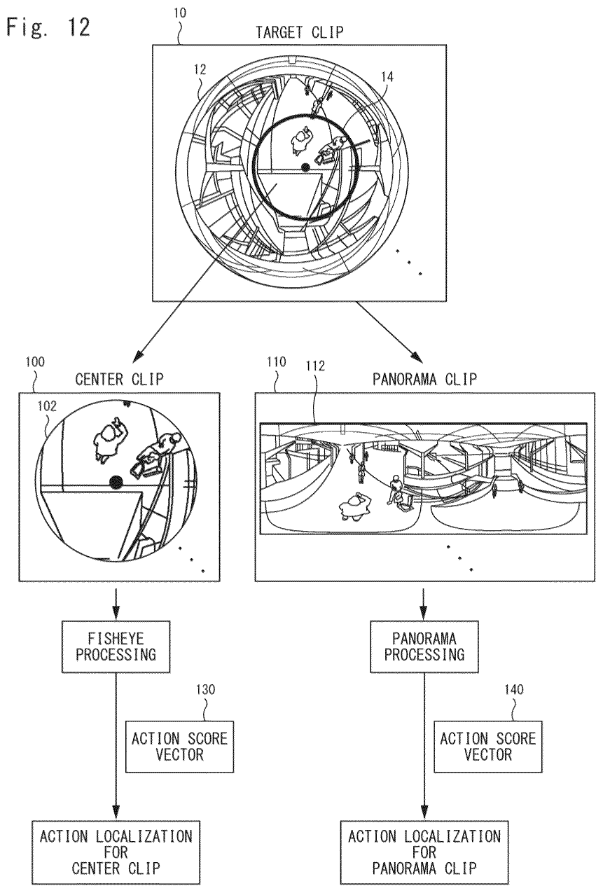

FIG. 12 illustrates an overview of the action localization apparatus 2000 of the second example embodiment. It is noted that the overview illustrated by FIG. 12 shows an example of operations of the action localization apparatus 2000 of the second example embodiment to make it easy to understand the action localization apparatus 2000 of the second example embodiment, and does not limit or narrow the scope of possible operations of the action localization apparatus 2000 of the second example embodiment.

In the target clip 10, persons appear at different angles. NPL1 addresses this issue by transforming the video frames obtained from the fisheye camera into panoramic images, and analyzing the panoramic images to detect and localize actions.

However, in this way, persons located around the center (the optical axis of a fisheye lens in top view) may be deformed by the transformation to the panoramic image. Regarding this problem, the way performed by the action localization apparatus 2000 could be more effective than that described in NPL1 to localize the actions happened around the optical axis of the fisheye lens since it does not deform the persons located around the center.

Thus, the action localization apparatus 2000 of the second example embodiment generates two different types of clips from the target clip 10, and performs two different types of methods to compute the action scores on these two clips. By doing so, the actions in the target clip 10 can be localized more precisely. Hereinafter those two types of clips are called “center clip 100” and “panorama clip 110”, respectively. In addition, the method performed on the center clip 100 is called “fisheye processing”, whereas the method performed on the panorama clip 110 is called “panorama processing”.

The center clip 100 is a sequence of center regions of the target images 12. To generate the center clip 100, the action localization apparatus 2000 retrieves a center region 14 from each of the target images 12. The center clip 100 is generated as a sequence of the center regions 14. The center region 14 is a circular region whose center is located at a position corresponding to the optical axis of the fisheye camera 30 and whose radius is predefined. The position corresponding to the optical axis of the fisheye camera 30 may be detected in the way disclosed by NPL1. Hereinafter, each image (i.e., the center region 14) included in the center clip 100 is called “center image 112”.

The panorama clip 110 is a sequence of the target images that are transformed into panoramic images. To generate the panorama clip 110, the action localization apparatus 2000 transforms each target image 12 into a panoramic image. The panorama clip 110 is generated as a sequence of those panoramic images. The target images 12 may be transformed into a panoramic image using a method disclosed by NPL1. Hereinafter, each image included in the panorama clip 110 is called “panorama image 112”.

The fisheye processing is a method to compute the action scores from the center clip 100 in a way similar to the way that the action localization apparatus 2000 of the first example embodiment computes the action scores for the target image 10. Specifically, the fisheye processing includes: detecting one or more persons 40 from the center clip 100; generating the person clip 60 for each of the persons 40 detected from the center clip 100; extracting the feature map 90 from each of the person clips 60; and computing the action scores based on the feature maps 90. Hereinafter, a vector showing the action scores computed for the center clip 100 is called “action score vector 130”.

The panorama processing is a method to compute the action scores in a way similar to the way disclosed by NPL1. Specifically, the panorama processing may be performed as follows. The action localization apparatus 2000 computes a feature map (spatial-temporal features) of the panorama clip 110 by, for example, inputting the panorama clip 110 into a neural network, such as a 3D CNN, that can extract spatial-temporal features as a feature map from a sequence of images. Then, the action localization apparatus 2000 computes a binary mask with person detection for the panorama clip 110, resizes the binary bask to the same width and height as the feature map, and multiply the feature map with the binary mask to obtain a masked feature map. The masked feature map is divided into multiple blocks. The action localization apparatus 2000 performs pooling on each block and then input each block into a fully-connected layer, thereby obtaining the action scores for each block. The action scores obtained for each block is aggregated into a single vector that shows the action scores for a whole of the panorama clip 110. Hereinafter, this vector is called “action score vector 140”.

As described above, the action localization apparatus 2000 obtains the action score vector 130 as a result of the fisheye processing and the action score vector 140 as a result of the panorama processing. The action localization apparatus 2000 localizes each action in the target clip 100 using the action score vector 130 and the action score vector 140.

In some implementations, the action localization apparatus 2000 separately uses the action score vector 130 and the action score vector 140 as illustrated by FIG. 12. In this case, the action localization apparatus 2000 performs action localization on the center clip 100 using the action score vector 130 in a way similar to the way that the action localization apparatus 2000 of the first example embodiment performs action localization on the target clip 10 using the action score vector 50. As a result, the actions detected from the center clip 110 are localized. In addition, the action localization apparatus 2000 performs action localization on the panorama clip 110 using the action sore vector 140 in a way similar to the way disclosed by NPL1. As a result, the actions detected from the panorama clip 110 are localized. Then, the action localization apparatus 2000 aggregates the result of the action localization performed on the center clip 100 and the result of the action localization performed on the panorama clip 110, thereby localize the actions of the detected action classes for a whole of the target clip 10.

In other implementations, the action localization apparatus 2000 aggregates the action score vector 130 and the action score vector 140 into a single vector called “aggregated action score vector”. In this case, the action classes whose action scores are larger than or equal to the threshold Tc is handled to be detected. For each of the detected action classes, the action localization apparatus 2000 separately performs action localization on the center clip 100 and the panorama clip 110 using the aggregated action score vector instead of separately the action score vectors 130 and 140, and aggregates the result of the action localizations.

Except that the aggregated action score vector is used for class activation mapping, the action localization performed on the center clip 100 in this case is the same as that in the case where the action score vectors 130 and 140 are separately used. Similarly, except that the aggregated action score vector is used for class activation mapping, the action localization performed on the panorama clip 110 in this case is the same as that in the case where the action score vector 130 and 140 are separately used.

### Example of Functional Configuration

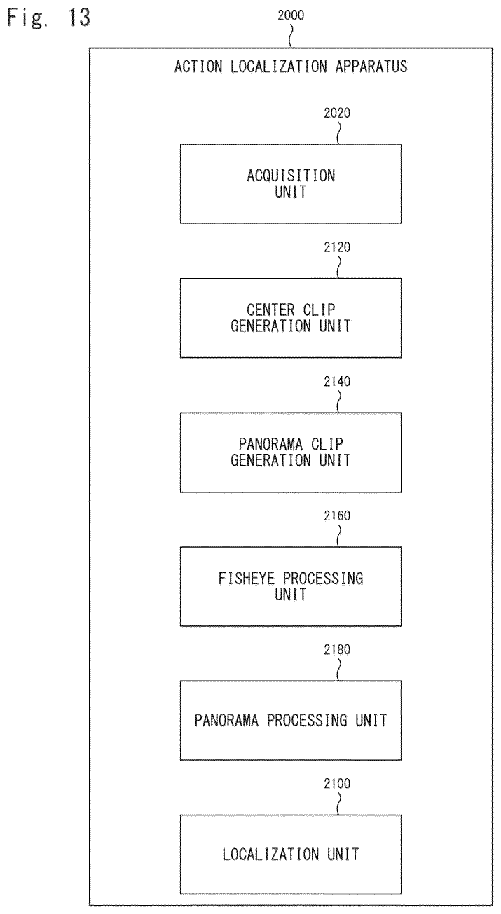

FIG. 13 is a block diagram that illustrates an example of the functional configuration of the action localization apparatus 2000 of the second example embodiment. It has the acquisition unit 2020, a center clip generation unit 2120, panorama clip generation unit 2140, fisheye processing unit 2160, panorama processing unit 2180, and the localization unit 2100. The acquisition unit 2020 acquires the target clip 10 as mentioned in the first example embodiment. The center clip generation unit 2120 generates the center clip 100 from the target clip 10. The panorama clip generation unit 2140 generates the panorama clip 110 from the target clip 10. The fisheye processing unit 2160 performs the fisheye processing on the center clip 100 to compute the action score vector 130. It is noted that the person clip generation unit 2040, the feature extraction unit 2060, and the score computation unit 2080 are included in the fisheye processing unit 2160 although they are not depicted in FIG. 13. The panorama processing unit 2180 performs the panorama processing on the panorama clip 110 to compute the action score vector 140. The localization unit 2100 performs the action localization for the target clip 10 using the action score vector 130 and the action score vector 140.

### Example of Hardware Configuration

Like the action localization apparatus 2000 of the first example embodiment, the action localization apparatus 2000 of the second example embodiment may have a hardware configuration depicted by FIG. 3. However, the storage device 1080 of the second example embodiment may further include the program with which the functional configurations of the action localization apparatus 2000 of the second example embodiment are realized.

### <Flow of Processes>

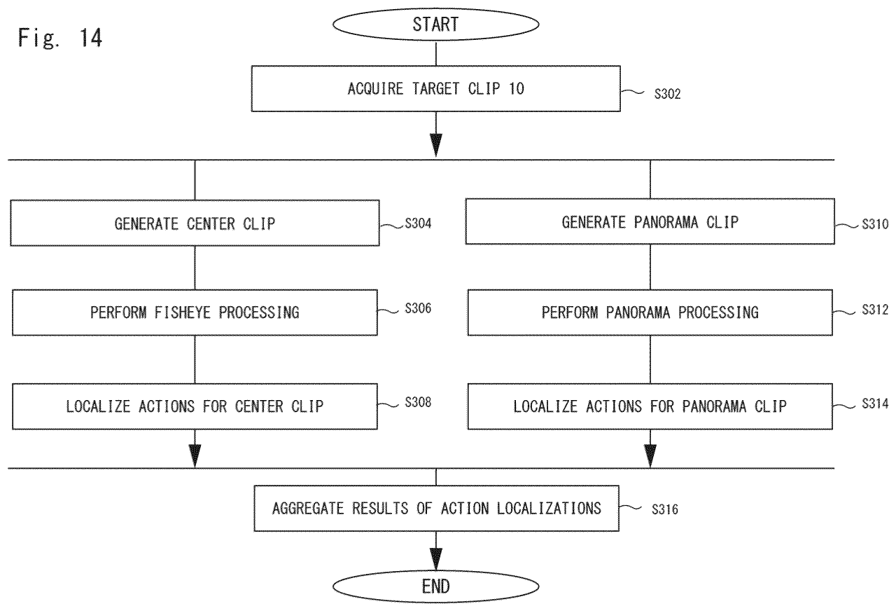

FIG. 14 is a flowchart illustrating a flow of processes that are performed by the action localization apparatus 2000 of the second example embodiment. The acquisition unit 2020 acquires the target clip 10 (S302). Between Step S302 and S316, there are two sequences of processes that are depicted as being performed in parallel. The first sequence of processes includes Steps S304 to S308 and performed to localize the actions in the center clip 100. On the other hand, the second sequence of processes includes Steps S310 to S314 that are performed to localize the actions in the panorama clip 110. It is noted that, in other implementations, those sequences may be performed sequentially, not in parallel.

The first sequence of processes is performed as follows. The center clip generation unit 2120 generates the center clip 100 (S304). The fisheye processing unit 2160 performs the fisheye processing on the center clip 100 to compute the action score vector 130 (S306). The localization unit 2100 localizes the action of the detected action classes for the center clip 100 using the action score vector 130 (S308).

The second sequence of processes is performed as follows. The panorama clip generation unit 2140 generates the center clip 100 (S310). The panorama processing unit 2180 performs the panorama processing on the panorama clip 110 to compute the action score vector 140 (S312). The localization unit 2100 localizes the actions of the detected action classes for the panorama clip 100 using the action score vector 140 (S308).

The localization unit 2100 aggregates the results of the action localization for the center clip 100 and the action localization for the panorama clip 110.

It is noted that the flowchart in FIG. 14 assumes that the action score vectors 130 and 140 are separately used to localize the actions. However, as mentioned above, the action localization may be performed using the aggregated action score vector, instead of separately using the action score vectors 130 and 140. In this case, after the fisheye processing and the panorama processing are finished, the aggregated action score vector is computed and then the action localization for the center clip 100 and that for the panorama clip 110 are performed using the aggregated action score vector.

<Output from Action Localization Apparatus 2000>

The action localization apparatus 2000 of the second example embodiment may output the output information similar to that output by the action localization apparatus 2000 of the first example embodiment. However, the output information of the second example embodiment may indicate aggregated results of the action localization for the center clip 100 and that for the panorama clip 110. For example, in the case where the output information includes the target clip 10 on which the bounding box 220 and the annotation 230 are superimposed as illustrated by FIG. 10, the action localization apparatus 2000 generates the bounding box 220 and the annotation 230 for both the persons whose actions are determined based on the result of the fisheye processing and the persons whose actions are determined based on the result of the panorama processing. The same applies to the case where the map 240 and the annotation 230 are superimposed on the target clip 10 as illustrated by FIG. 11.

In some cases, there may be a person who is included in both the center clip 100 and the panorama clip 110. In this case, the localization unit 2100 may obtain the class activation maps for the person from both the center clip 100 and the panorama clip 110. The localization unit 2100 may combine those class activation maps and localize the action of the person based on the combined class activation maps. The class activation maps may be combined by taking the intersection or mean thereof.

### <Optimization of Trainable Parameter>

The action localization apparatus 2000 of the second example embodiment further includes trainable parameters that are used for the panorama processing in addition to the trainable parameters mentioned in the first example embodiment. In a similar manner to that employed in the first example embodiment, the trainable parameters of the action localization apparatus 2000 of the second example embodiment may be optimized in advance using the multiple training data. However, in this example embodiment, the loss may be computed using the aggregated action score vector instead of the action score vector 50. Specifically, the loss may be computed to represent the difference between the ground truth data of the aggregated action score that is indicated by the training data and the aggregated action score that is computed by the action localization apparatus 2000 of the second example embodiment in response to the test clip being input thereinto.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

The whole or part of the example embodiments disclosed above can be described as, but not limited to, the following supplementary notes.

### SUPPLEMENTARY NOTES

### Supplementary Note 1

An action localization apparatus comprising:
at least one memory that is configured to store instructions; and
at least one processor that is configured to execute the instructions to:
acquire a target clip that is a sequence of target images, the target image being a fisheye image in which one or more persons are captured in substantially top-view;
detect one or more persons from the target clip;
generate a person clip from the target clip for each of the persons detected from the target clip, the person clip being a sequence of person images each of which is a partial region of the target image and includes the detected person corresponding to that person clip;
extract a feature map from each of the person clip;
compute, for each of predefined action classes, an action score that indicates confidence of an action of that action class being included in the target clip based on the feature maps extracted from the person clips, the action class being a type of action; and
localize each action whose action class has the action score larger than or equal to a threshold by performing class activation mapping on each of the person clips.

### Supplementary Note 2

The action localization apparatus according to supplementary note 1,
wherein the localization of the action includes, for each of the person clip:
   generating, for each of the action classes whose action score is larger than or equal to the threshold, a class activation map using the action score of that action class and the feature map extracted from that person clip;
   determining the class activation map that shows highest relevance to the action score of the action class corresponding thereto; and
   determining that the action class corresponding to the determined class activation map is the action class of the action included in that person clip.

### Supplementary Note 3

The action localization apparatus according to supplementary note 1 or 2,
wherein the computation of the action scores includes:
computing, for each of the person clips, an intermediate vector that indicates confidence of an action of the action class being included in that person clip for each of the predefined action classes; and
aggregating the intermediate vectors into an action score vector that indicates the action scores of the predefined action classes.

### Supplementary Note 4

The action localization apparatus according to supplementary note 3,
wherein the extraction of the feature map and the computation of the action scores are performed by pre-trained neural networks, and
wherein the pre-trained neural networks are trained using a training dataset that includes a test clip and a vector indicating maximum confidence for each of the action classes that is included in the test clip, the test clip including fisheye images in which one or more persons are captured in substantially top-view.

### Supplementary Note 5

The action localization apparatus according to supplementary note 3 or 4,
wherein the intermediate vectors are aggregated into the action score vector using a log sum exponential function.

### Supplementary Note 6

The action localization apparatus according to any one of supplementary notes 1 to 5,
wherein at least one processor that is configured to further execute the instructions to:
generate a center clip that is a sequence of center images each of which is generated by cropping a center region from the target image corresponding thereto;
generate a panorama clip that is a sequence of panorama images each of which is generated by transforming the target image corresponding thereto into a panoramic image; and
localize the actions included in the target clip by localizing the actions included in the center clip, localizing the actions included in the panorama clip, and aggregating results of the localization of the actions included in the center clip and the localization of the actions included in the panorama clip,
wherein the localization of the actions included in the center clip includes:
   detecting one or more persons from the center clip;
   generating the person clip from the center clip for each of the persons detected from the center clip;
   extracting the feature map from each of the person clip;
   computing the action score for each of the predefined action classes based on the feature maps extracted from the person clips; and
   localizing each action whose action class has the action score larger than or equal to the threshold by performing class activation mapping on each of the person clips.

### Supplementary Note 7

A control method performed by a computer, comprising:
acquiring a target clip that is a sequence of target images, the target image being a fisheye image in which one or more persons are captured in substantially top-view;
detecting one or more persons from the target clip;
generating a person clip from the target clip for each of the persons detected from the target clip, the person clip being a sequence of person images each of which is a partial region of the target image and includes the detected person corresponding to that person clip;
extracting a feature map from each of the person clip;
computing, for each of predefined action classes, an action score that indicates confidence of an action of that action class being included in the target clip based on the feature maps extracted from the person clips, the action class being a type of action; and
localizing each action whose action class has the action score larger than or equal to a threshold by performing class activation mapping on each of the person clips.

### Supplementary Note 8

The control method according to supplementary note 7,
wherein the localization of the action includes, for each of the person clip:
   generating, for each of the action classes whose action score is larger than or equal to the threshold, a class activation map using the action score of that action class and the feature map extracted from that person clip;
   determining the class activation map that shows highest relevance to the action score of the action class corresponding thereto; and
   determining that the action class corresponding to the determined class activation map is the action class of the action included in that person clip.

### Supplementary Note 9

The control method according to supplementary note 7 or 8,
wherein the computation of the action scores includes:
computing, for each of the person clips, an intermediate vector that indicates confidence of an action of the action class being included in that person clip for each of the predefined action classes; and
aggregating the intermediate vectors into an action score vector that indicates the action scores of the predefined action classes.

### Supplementary Note 10

The control method according to supplementary note 9,
wherein the extraction of the feature map and the computation of the action scores are performed by pre-trained neural networks, and
wherein the pre-trained neural networks are trained using a training dataset that includes a test clip and a vector indicating maximum confidence for each of the action classes that is included in the test clip, the test clip including fisheye images in which one or more persons are captured in substantially top-view.

### Supplementary Note 11

The control method according to supplementary note 9 or 10,
wherein the intermediate vectors are aggregated into the action score vector using a log sum exponential function.

### Supplementary Note 12

The control method according to any one of supplementary notes 7 to 11, further comprising:
generating a center clip that is a sequence of center images each of which is generated by cropping a center region from the target image corresponding thereto;
generating a panorama clip that is a sequence of panorama images each of which is generated by transforming the target image corresponding thereto into a panoramic image; and
localizing the actions included in the target clip by localizing the actions included in the center clip, localizing the actions included in the panorama clip, and aggregating results of the localization of the actions included in the center clip and the localization of the actions included in the panorama clip,
wherein the localization of the actions included in the center clip includes:
   detecting one or more persons from the center clip;
   generating the person clip from the center clip for each of the persons detected from the center clip;
   extracting the feature map from each of the person clip;
   computing the action score for each of the predefined action classes based on the feature maps extracted from the person clips; and
   localizing each action whose action class has the action score larger than or equal to the threshold by performing class activation mapping on each of the person clips.

### Supplementary Note 13

A non-transitory computer-readable storage medium storing a program that causes a computer to execute:
acquiring a target clip that is a sequence of target images, the target image being a fisheye image in which one or more persons are captured in substantially top-view;
detecting one or more persons from the target clip;
generating a person clip from the target clip for each of the persons detected from the target clip, the person clip being a sequence of person images each of which is a partial region of the target image and includes the detected person corresponding to that person clip;
extracting a feature map from each of the person clip;
computing, for each of predefined action classes, an action score that indicates confidence of an action of that action class being included in the target clip based on the feature maps extracted from the person clips, the action class being a type of action; and
localizing each action whose action class has the action score larger than or equal to a threshold by performing class activation mapping on each of the person clips.

### Supplementary Note 14

The storage medium according to supplementary note 13,
wherein the localization of the action includes, for each of the person clip:
   generating, for each of the action classes whose action score is larger than or equal to the threshold, a class activation map using the action score of that action class and the feature map extracted from that person clip;
   determining the class activation map that shows highest relevance to the action score of the action class corresponding thereto; and
   determining that the action class corresponding to the determined class activation map is the action class of the action included in that person clip.

### Supplementary Note 15

The storage medium according to supplementary note 13 or 14,
wherein the computation of the action scores includes:
computing, for each of the person clips, an intermediate vector that indicates confidence of an action of the action class being included in that person clip for each of the predefined action classes; and
aggregating the intermediate vectors into an action score vector that indicates the action scores of the predefined action classes.

### Supplementary Note 16

The storage medium according to supplementary note 15,
wherein the extraction of the feature map and the computation of the action scores are performed by pre-trained neural networks, and
wherein the pre-trained neural networks are trained using a training dataset that includes a test clip and a vector indicating maximum confidence for each of the action classes that is included in the test clip, the test clip including fisheye images in which one or more persons are captured in substantially top-view.

### Supplementary Note 17

The storage medium according to supplementary note 15 or 16,
wherein the intermediate vectors are aggregated into the action score vector using a log sum exponential function.

### Supplementary Note 18

The storage medium according to any one of supplementary notes 13 to 17,
wherein the program causes the computer to further execute:
generating a center clip that is a sequence of center images each of which is generated by cropping a center region from the target image corresponding thereto;
generating a panorama clip that is a sequence of panorama images each of which is generated by transforming the target image corresponding thereto into a panoramic image; and
localizing the actions included in the target clip by localizing the actions included in the center clip, localizing the actions included in the panorama clip, and aggregating results of the localization of the actions included in the center clip and the localization of the actions included in the panorama clip,
wherein the localization of the actions included in the center clip includes:
   detecting one or more persons from the center clip;
   generating the person clip from the center clip for each of the persons detected from the center clip;
   extracting the feature map from each of the person clip;
   computing the action score for each of the predefined action classes based on the feature maps extracted from the person clips; and
   localizing each action whose action class has the action score larger than or equal to the threshold by performing class activation mapping on each of the person clips.

### REFERENCE SIGNS LIST

10 target clip
12 target image
14 center region
20 video
22 video frame
30 fisheye camera
40 person
50, 130, 140 action score vector 50
60 person clip
62 person image
70 network
80, 90 feature map
100 center clip
102 center image
110 panorama clip
112 panorama image
200 fully connected layer
210 intermediate vector
220 bounding box
230 annotation
240 map
1000 computer
1020 bus
1040 processor
1060 memory
1080 storage device
1100 input/output interface
1120 network interface
2000 action localization apparatus
2020 acquisition unit
2040 person clip generation unit
2060 feature extraction unit
2080 score computation unit
2100 localization unit
2120 center clip generation unit
2140 panorama clip generation unit
2160 fisheye processing unit
2180 panorama processing unit

What is claimed is:

1. An action localization apparatus comprising:
at least one memory that is configured to store instructions; and
at least one processor that is configured to execute the instructions to:
acquire a target clip that is a sequence of target images, the target image being a fisheye image in which one or more persons are captured in substantially top-view;
detect one or more persons from the target clip;
generate a person clip from the target clip for each of the persons detected from the target clip, the person clip being a sequence of person images each of which is a partial region of the target image and includes the detected person corresponding to that person clip;
extract a feature map from each of the person clip;
compute, for each of predefined action classes, an action score that indicates confidence of an action of that action class being included in the target clip based on the feature maps extracted from the person clips, the action class being a type of action; and
localize each action whose action class has the action score larger than or equal to a threshold by performing class activation mapping on each of the person clips.

2. The action localization apparatus according to claim 1,
wherein the localization of the action includes, for each of the person clip:
generating, for each of the action classes whose action score is larger than or equal to the threshold, a class activation map using the action score of that action class and the feature map extracted from that person clip;
determining the class activation map that shows highest relevance to the action score of the action class corresponding thereto; and
determining that the action class corresponding to the determined class activation map is the action class of the action included in that person clip.

3. The action localization apparatus according to claim 1,
wherein the computation of the action scores includes:
computing, for each of the person clips, an intermediate vector that indicates confidence of an action of the action class being included in that person clip for each of the predefined action classes; and
aggregating the intermediate vectors into an action score vector that indicates the action scores of the predefined action classes.

4. The action localization apparatus according to claim 3,
wherein the extraction of the feature map and the computation of the action scores are performed by pre-trained neural networks, and
wherein the pre-trained neural networks are trained using a training dataset that includes a test clip and a vector indicating maximum confidence for each of the action classes that is included in the test clip, the test clip including fisheye images in which one or more persons are captured in substantially top-view.

5. The action localization apparatus according to claim 3,
wherein the intermediate vectors are aggregated into the action score vector using a log sum exponential function.

6. The action localization apparatus according to claim 1,
wherein at least one processor that is configured to further execute the instructions to:
generate a center clip that is a sequence of center images each of which is generated by cropping a center region from the target image corresponding thereto;
generate a panorama clip that is a sequence of panorama images each of which is generated by transforming the target image corresponding thereto into a panoramic image; and
localize the actions included in the target clip by localizing the actions included in the center clip, localizing the actions included in the panorama clip, and aggregating results of the localization of the actions included in the center clip and the localization of the actions included in the panorama clip,
wherein the localization of the actions included in the center clip includes:
detecting one or more persons from the center clip;
generating the person clip from the center clip for each of the persons detected from the center clip;
extracting the feature map from each of the person clip;
computing the action score for each of the predefined action classes based on the feature maps extracted from the person clips; and
localizing each action whose action class has the action score larger than or equal to the threshold by performing class activation mapping on each of the person clips.

7. A control method performed by a computer, comprising:
acquiring a target clip that is a sequence of target images, the target image being a fisheye image in which one or more persons are captured in substantially top-view;
detecting one or more persons from the target clip;
generating a person clip from the target clip for each of the persons detected from the target clip, the person clip being a sequence of person images each of which is a partial region of the target image and includes the detected person corresponding to that person clip;
extracting a feature map from each of the person clip;
computing, for each of predefined action classes, an action score that indicates confidence of an action of that action class being included in the target clip based on the feature maps extracted from the person clips, the action class being a type of action; and
localizing each action whose action class has the action score larger than or equal to a threshold by performing class activation mapping on each of the person clips.

8. The control method according to claim 7,
wherein the localization of the action includes, for each of the person clip:
generating, for each of the action classes whose action score is larger than or equal to the threshold, a class activation map using the action score of that action class and the feature map extracted from that person clip;
determining the class activation map that shows highest relevance to the action score of the action class corresponding thereto; and
determining that the action class corresponding to the determined class activation map is the action class of the action included in that person clip.

9. The control method according to claim 7,
wherein the computation of the action scores includes:
computing, for each of the person clips, an intermediate vector that indicates confidence of an action of the action class being included in that person clip for each of the predefined action classes; and
aggregating the intermediate vectors into an action score vector that indicates the action scores of the predefined action classes.

10. The control method according to claim 9,
wherein the extraction of the feature map and the computation of the action scores are performed by pre-trained neural networks, and
wherein the pre-trained neural networks are trained using a training dataset that includes a test clip and a vector indicating maximum confidence for each of the action classes that is included in the test clip, the test clip including fisheye images in which one or more persons are captured in substantially top-view.

11. The control method according to claim 9,
wherein the intermediate vectors are aggregated into the action score vector using a log sum exponential function.

12. The control method according to claim 7, further comprising:
generating a center clip that is a sequence of center images each of which is generated by cropping a center region from the target image corresponding thereto;
generating a panorama clip that is a sequence of panorama images each of which is generated by transforming the target image corresponding thereto into a panoramic image; and
localizing the actions included in the target clip by localizing the actions included in the center clip, localizing the actions included in the panorama clip, and aggregating results of the localization of the actions included in the center clip and the localization of the actions included in the panorama clip,
wherein the localization of the actions included in the center clip includes:
detecting one or more persons from the center clip;
generating the person clip from the center clip for each of the persons detected from the center clip;
extracting the feature map from each of the person clip;
computing the action score for each of the predefined action classes based on the feature maps extracted from the person clips; and
localizing each action whose action class has the action score larger than or equal to the threshold by performing class activation mapping on each of the person clips.

13. A non-transitory computer-readable storage medium storing a program that causes a computer to execute:
acquiring a target clip that is a sequence of target images, the target image being a fisheye image in which one or more persons are captured in substantially top-view;
detecting one or more persons from the target clip;
generating a person clip from the target clip for each of the persons detected from the target clip, the person clip being a sequence of person images each of which is a partial region of the target image and includes the detected person corresponding to that person clip;
extracting a feature map from each of the person clip;
computing, for each of predefined action classes, an action score that indicates confidence of an action of that action class being included in the target clip based on the feature maps extracted from the person clips, the action class being a type of action; and
localizing each action whose action class has the action score larger than or equal to a threshold by performing class activation mapping on each of the person clips.

14. The storage medium according to claim 13,
wherein the localization of the action includes, for each of the person clip:
generating, for each of the action classes whose action score is larger than or equal to the threshold, a class activation map using the action score of that action class and the feature map extracted from that person clip;
determining the class activation map that shows highest relevance to the action score of the action class corresponding thereto; and
determining that the action class corresponding to the determined class activation map is the action class of the action included in that person clip.

15. The storage medium according to claim 13,
wherein the computation of the action scores includes:
computing, for each of the person clips, an intermediate vector that indicates confidence of an action of the action class being included in that person clip for each of the predefined action classes; and
aggregating the intermediate vectors into an action score vector that indicates the action scores of the predefined action classes.

16. The storage medium according to claim 15,
wherein the extraction of the feature map and the computation of the action scores are performed by pre-trained neural networks, and
wherein the pre-trained neural networks are trained using a training dataset that includes a test clip and a vector indicating maximum confidence for each of the action classes that is included in the test clip, the test clip including fisheye images in which one or more persons are captured in substantially top-view.

17. The storage medium according to claim 15,
wherein the intermediate vectors are aggregated into the action score vector using a log sum exponential function.

18. The storage medium according to claim 13,
wherein the program causes the computer to further execute:
generating a center clip that is a sequence of center images each of which is generated by cropping a center region from the target image corresponding thereto;
generating a panorama clip that is a sequence of panorama images each of which is generated by transforming the target image corresponding thereto into a panoramic image; and
localizing the actions included in the target clip by localizing the actions included in the center clip, localizing the actions included in the panorama clip, and aggregating results of the localization of the actions included in the center clip and the localization of the actions included in the panorama clip,
wherein the localization of the actions included in the center clip includes:
detecting one or more persons from the center clip;
generating the person clip from the center clip for each of the persons detected from the center clip;
extracting the feature map from each of the person clip;
computing the action score for each of the predefined action classes based on the feature maps extracted from the person clips; and
localizing each action whose action class has the action score larger than or equal to the threshold by performing class activation mapping on each of the person clips.
